(19) United States
(12) Patent Application Publication
(10) Pub. No.: US 2021/0144527 A1
(43) Pub. Date: May 13, 2021

(54) Vehicle and Control Method Thereof

(71) Applicants: Hyundai Motor Company, Seoul (KR); Kia Motors Corporation, Seoul (KR)

(72) Inventor: Sunghwan Choi, Yongin-si (KR)

(21) Appl. No.: 16/794,711

(22) Filed: Feb. 19, 2020

(30) Foreign Application Priority Data
Nov. 12, 2019 (KR) 10-2019-0144202

(51) Int. Cl. H04W 4/44; H04L 29/06; H04N 7/04

(52) U.S. Cl. CPC H04W 4/44; H04L 69/24; H04N 7/04; H04L 69/04

(57) ABSTRACT

A vehicle includes a camera and a transceiver. A controller receives encoding specification information from the server, encodes the image based on a specification corresponding to the encoding specification information, and directs the transceiver to transmit the encoded image to the server. The encoding specification information is determined based on traffic volume of the server, data usage of the vehicle, or traffic information of the vehicle.

### CROSS-REFERENCE TO RELATED APPLICATION

This application claims priority to Korean Patent Application No. 10-2019-0144202,filed in the Korean Intellectual Property Office on Nov. 12, 2019, which application is hereby incorporated herein by reference.

### TECHNICAL FIELD

The disclosure relates to a vehicle for transmitting a captured image to outside, and a control method thereof.

### BACKGROUND

In general, even when the user of a vehicle is not located in the vehicle, the user may request an image of the vehicle from the vehicle through the user terminal, and may check a situation around the vehicle based on the image received from the vehicle.

However, since the resolution, format, quantity, and capacity of the image of the vehicle are fixed, an excessive usage fee may be charged according to the capacity of the image of the vehicle, and processing time may be long, making it difficult to check the real-time image.

### SUMMARY

Therefore, an embodiment of the present invention provides a vehicle which processes and transmits an image of the vehicle variably based on a processing time and a situation around the vehicle, and a control method thereof.

In accordance with an embodiment of the disclosure, a vehicle includes a camera configured to capture an image of the vehicle, a transceiver configured to communicate with a server, and a controller that, when receiving encoding specification information from the server, is configured to encode the image based on a specification corresponding to the encoding specification information and to control the transceiver to transmit the encoded image to the server.

The controller may be configured to adjust at least one of a frame format, a quantity, a resolution, or a compression rate in encoding based on a specification corresponding to the encoding specification information.

The encoding specification information may be determined based on at least one of traffic volume of the server, data usage of the vehicle, traffic information of the vehicle, or location information of the vehicle.

The controller may be configured to adjust an encoding specification in a decreasing direction in proportion to the traffic volume of the server based on the encoding specification information.

The controller may be configured to adjust an encoding specification in a decreasing direction in proportion to the data usage of the vehicle based on the encoding specification information.

The controller may be configured to adjust the encoding specification in an increasing direction in proportion to the traffic amount indicated by the traffic information of the vehicle based on the encoding specification information.

The controller may be configured to adjust the encoding specification in an increasing direction in proportion to a degree of congestion indicated by the location information of the vehicle based on the encoding specification information.

The controller may be configured to determine a type of the image based on an object in the image and encode the image based on encoding specification information corresponding to the determined type among encoding specification information received from the server.

The controller may be configured to determine the type of the image as a type that requires high specification encoding when the object in the image is at least one of a moving object or character.

In accordance with another aspect of the disclosure, a control method of a vehicle including a camera configured to capture an image of the vehicle and a transceiver configured to communicate with a server, includes, when receiving encoding specification information from the server, encoding the image based on a specification corresponding to the encoding specification information, and controlling the transceiver to transmit the encoded image to the server.

The control method may further include adjusting at least one of a frame format, a quantity, a resolution, or a compression rate in encoding based on a specification corresponding to the encoding specification information.

The encoding specification information may be determined based on at least one of traffic volume of the server, data usage of the vehicle, traffic information of the vehicle, or location information of the vehicle.

The control method may further include adjusting an encoding specification in a decreasing direction in proportion to the traffic volume of the server based on the encoding specification information.

The control method may further include adjusting an encoding specification in a decreasing direction in proportion to the data usage of the vehicle based on the encoding specification information.

The control method may further include adjusting the encoding specification in an increasing direction in proportion to the traffic amount indicated by the traffic information of the vehicle based on the encoding specification information.

The control method may further include adjusting the encoding specification in an increasing direction in proportion to a degree of congestion indicated by the location information of the vehicle based on the encoding specification information.

The control method may further include determining a type of the image based on an object in the image, and encoding the image based on encoding specification information corresponding to the determined type among encoding specification information received from the server.

Determining the type of the image may include determining the type of the image as a type that requires high specification encoding when the object in the image is at least one of a moving object or character.

### BRIEF DESCRIPTION OF THE DRAWINGS

These and/or other aspects of the invention will become apparent and more readily appreciated from the following description of the embodiments, taken in conjunction with the accompanying drawings in which:

FIG. 1 is a block diagram illustrating a configuration of an image sharing system including a vehicle, a server, and a user terminal according to an embodiment of the disclosure;

FIG. 2 is a control block diagram of a vehicle according to an embodiment of the disclosure;

FIG. 3 is a control block diagram of a server according to an embodiment of the disclosure;

FIG. 4 is a diagram illustrating a specification corresponding to encoding specification information according to an embodiment of the disclosure;

FIG. 5 is a diagram illustrating encoding specification information according to a traffic volume of a server according to an embodiment of the disclosure;

FIG. 6 is a diagram illustrating encoding specification information according to data usage of a vehicle according to an embodiment of the disclosure;

FIG. 7 is a diagram illustrating encoding specification information according to traffic amount around a vehicle according to an embodiment of the disclosure;

FIG. 8 is a diagram illustrating encoding specification information according to congestion degree at a location of a vehicle according to an embodiment of the disclosure;

FIG. 9 is a diagram illustrating an encoding specification that varies according to a type of an image according to an embodiment of the disclosure;

FIG. 10 is a flowchart illustrating a case of encoding an image based on encoding specification information in a control method of a vehicle according to an embodiment of the disclosure; and

FIG. 11 is a flowchart illustrating a case in which an image is encoded in consideration of a type of an image in a control method of a vehicle according to an embodiment of the disclosure.

### DETAILED DESCRIPTION OF ILLUSTRATIVE EMBODIMENTS

Like reference numerals refer to like elements throughout the specification. Not all elements of embodiments of the disclosure will be described, and description of what is commonly known in the art or what overlaps each other in the embodiments will be omitted.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, embodiments of a vehicle and a method of controlling the vehicle according to an aspect will be described in detail with reference to the accompanying drawings.

FIG. 1 is a block diagram illustrating a configuration of an image sharing system including a vehicle, a server, and a user terminal according to an embodiment of the disclosure.

Referring to FIG. 1, an image sharing system 1 according to an embodiment includes a vehicle 10, a server 20, and a user terminal 30, and includes a network 40 that supports communication between components.

Each of the vehicle 10, the server 20, and the user terminal 30 may be connected to the network 40 through wireless or wired communication to communicate with each other. At this time, the communication method of each of the wireless communication and the wired communication may be used in a known communication method.

To this end, the network 40 may be at least one of a telecommunications network, for example, a computer network (e.g., LAN or WAN), an Internet, or a telephone network.

A user of the vehicle 10 may share an image captured by the vehicle 10 even when the user is not located in the vehicle 10.

Specifically, the user of the vehicle 10 may request the server 20 for an image regarding the vehicle 10 through the user terminal 30. That is, the user terminal 30 may transmit the image request signal to the server 20 through the network 40 based on the user's input.

As such, the user terminal 30 may receive an input from the user, and may exchange data with the server 20 and the network 40.

The user terminal 30 may include at least one of, for example, a smartphone, a tablet personal computer, a mobile phone, a video phone, an e-book reader, a desktop personal computer, a laptop personal computer, a netbook computer, a personal digital assistant (PDA), a portable multimedia player (PMP), an MP3 player, a camera, or a wearable device. However, the user terminal 30 is not limited to the above examples, and a terminal capable of receiving an input from a user and communicating with the server 20 may be included in the user terminal 30 without limitation.

When the server 20 according to an embodiment receives an image request signal from the user terminal 30, the server 20 may request an image from the vehicle 10 corresponding to the image request signal. In addition, the server 20 may transmit the image received from the vehicle 10 to the user terminal 30.

At this time, the server 20 may determine the encoding specification of the image based on the traffic volume of the server 20 or the surrounding situation of the vehicle 10. The server 20 may adjust the encoding specification for the image to be received from the vehicle 10 by transmitting encoding specification information indicating the determined encoding specification to the vehicle 10.

When the vehicle 10 receives a request signal for an image from the server 20, the vehicle 10 according to an embodiment may transmit an image of the vehicle 10 obtained through a camera provided in the inside and the outside of the vehicle to the server 20.

In this case, the vehicle 10 may encode an image based on an encoding specification corresponding to the encoding specification information received from the server 20, and transmit the encoded image to the server 20.

The encoding specification of the vehicle 10 and the server 20 will be described later in detail.

In addition, FIG. 1 illustrates one vehicle 10 and one user terminal 30. However, the image sharing system 1 may include a plurality of vehicles and a plurality of user terminals, and the plurality of vehicles and the plurality of user terminals may communicate with the server 20.

FIG. 2 is a control block diagram of a vehicle according to an embodiment of the disclosure.

Referring to FIG. 2, the vehicle 10 according to an embodiment may include a camera 110 for capturing an image of the vehicle 10, a transceiver 120 for communicating with the server 20 through the network 40, a controller 130 that encodes an image based on encoding specification information received from the server 20 and directs the transceiver 120 to transmit the encoded image to the server 20, and a storage 140 for storing an image photographed through the camera 110 and various kinds of information necessary for controlling the vehicle 10.

The camera 110 according to an embodiment may capture an image of the vehicle 10. For example, the camera 110 may capture at least one of an external image of the vehicle 10 or an internal image of the vehicle 10.

In detail, the camera 110 may be provided in the body of the vehicle 10 to obtain an external image of the vehicle 10. For example, the camera 110 may be provided in plural and may be provided on at least one of the front, the rear, or the side of the vehicle 10 to obtain an image of at least one of the front, the rear, or the side of the vehicle 10.

In addition, the camera 110 may be provided inside the vehicle 10 to obtain an internal image of the vehicle 10.

If the position and the number of the camera 110 are the position and the number which may capture the external image or the internal image of the vehicle 10, the position and the number of the camera 110 is not limited.

The transceiver 120 according to an embodiment may be connected to the network 40 through wireless or wired communication to communicate with the server 20. At this time, the communication method of each of the wireless communication and the wired communication may be used in a known communication method.

The controller 130 according to an embodiment may encode an image of the vehicle 10 based on encoding specification information received from the server 20 and direct the transceiver to transmit the encoded image to the server.

The controller 130 may adjust at least one of a frame format, a quantity, a resolution, or a compression rate in encoding based on a specification corresponding to encoding specification information.

In this case, the encoding specification information may be determined based on at least one of a traffic volume of the server 20, a data usage of the vehicle 10, traffic information of the vehicle 10, and location information (e.g., GPS information) of the vehicle 10.

In detail, the controller 130 may adjust the encoding specification in a decreasing direction in proportion to the traffic volume of the server 20 based on the encoding specification information.

In addition, the controller 130 may adjust the encoding specification in a decreasing direction in proportion to the data usage of the vehicle 10 based on the encoding specification information.

The controller 130 may adjust the encoding specification in an increasing direction in proportion to the traffic amount indicated by the traffic information of the vehicle 10 based on the encoding specification information.

The controller 130 may adjust the encoding specification in an increasing direction in proportion to a degree of congestion indicated by the location information of the vehicle 10 based on the encoding specification information.

The controller 130 according to an embodiment may adjust the encoding specification based on the type of the image photographed through the camera 110.

In detail, the controller 130 may determine the type of the image based on the object in the image, and encode the image based on the encoding specification information corresponding to the determined type among the encoding specification information received from the server 20.

In this case, when the object in the image is at least one of a moving object or a character, the controller 130 may determine the type of the image as a type requiring high specification encoding. And when the object in the image is not at least one of a moving object or a character, the controller 130 may determine the type of the image as a type requiring low specification encoding.

In this manner, the server 20 may transmit a plurality of encoding specification information having a difference in encoding specification according to the type of the image to the vehicle 10. The vehicle 10 may encode each image based on encoding specification information of a type corresponding to each of the plurality of captured images (e.g., front image, rear image, left side image, right side image, internal image, etc.) among the plurality of encoding specification information.

The controller 130 may include at least one memory in which a program for performing the above-described operation and the operation described below is stored, and at least one processor for executing the stored program. In the case of a plurality of memories and processors, they may be integrated in one chip or may be provided in physically separated locations.

The storage 140 according to an embodiment may store the captured image and various information necessary for controlling the vehicle 10. In addition, the storage 140 may include information about a specification (e.g., resolution, format, amount, compression rate, etc.) corresponding to encoding specification information.

The storage 140 may be implemented as at least one of a non-volatile memory device (for example, a cache, Read Only Memory (ROM), Programmable ROM (PROM), Erasable Programmable ROM (EPROM), Electrically Erasable Programmable ROM (EEPROM), and flash memory), a volatile memory device (for example, Random Access Memory (RAM)), or a storage medium (for example, Hard Disk Drive (HDD) and Compact Disc Read Only Memory (CD-ROM)), although the storage 140 is not limited to these.

FIG. 3 is a control block diagram of a server according to an embodiment of the disclosure.

Referring to FIG. 3, a server 20 according to an embodiment may include a transceiver 210 for communicating with the vehicle 10 and the user terminal 30 via the network 40, a controller 220 for determining the encoding specification information and directing the transceiver 210 to transmit the encoding specification information and the image request signal to the vehicle 10, and a storage 230 which stores various kinds of information necessary for controlling the server 20.

The transceiver 210 according to an embodiment may communicate with the vehicle 10 and the user terminal 30 through the network 40. To this end, the transceiver 210 may be connected to the network 40 through wired communication or wireless communication. At this time, the communication method of each of the wireless communication and the wired communication may be used in a known communication method.

The controller 220 according to an embodiment may determine encoding specification information.

In detail, the controller 220 may determine encoding specification information based on at least one of a traffic volume of the server 20, a data usage of the vehicle 10, traffic information of the vehicle 10, or location information of the vehicle 10.

The controller 220 may determine encoding specification information in a direction of decreasing encoding specification in proportion to a traffic volume of the server 20.

In addition, the controller 220 may determine encoding specification information in a direction of decreasing encoding specification in proportion to data usage of the vehicle 10. To this end, the controller 220 may control the transceiver 210 to ask the vehicle 10 for information about data usage of the vehicle 10.

In addition, the controller 220 may determine encoding specification information in a direction of increasing encoding specification in proportion to the traffic amount indicated by the traffic information of the vehicle 10. To this end, the controller 220 may direct the transceiver 210 to request the location information of the vehicle 10 from the vehicle 10 and request the real time traffic information from an external server (not shown).

That is, the controller 220 may determine traffic information indicating a traffic amount in a section in which the vehicle 10 is located, based on the location information and the real-time traffic information of the vehicle 10, and may determine an encoding specification information based on the traffic information.

In addition, the controller 220 may determine the encoding specification information in a direction of increasing encoding specification in proportion to the degree of congestion indicated by the location information of the vehicle 10. To this end, the controller 220 may direct the transceiver 210 to ask the vehicle 10 for location information of the vehicle 10.

The controller 220 according to an embodiment may generate a plurality of encoding specification information having a difference in encoding specification according to an image type. In detail, the controller 220 determines encoding specification information based on at least one of a traffic volume of the server 20, a data usage of the vehicle 10, traffic information of the vehicle 10, or location information of the vehicle 10. Thereafter, the controller 220 may generate a plurality of encoding specification information by adjusting the encoding specification information determined according to the type of the image.

For example, the controller 220 may generate one encoding specification information by adjusting the degree of specification indicated by the encoding specification information determined for an image type requiring high specification encoding to increase. In addition, the controller 220 may generate another encoding specification information by adjusting the degree of specification indicated by the encoding specification information determined for an image type requiring low specification encoding to decrease.

The controller 220 may include at least one memory in which a program for performing the above-described operation and the operation described below is stored, and at least one processor for executing the stored program. In the case of a plurality of memories and processors, they may be integrated in one chip or may be provided in physically separated locations.

The storage 230 according to an embodiment may store the encoded image received from the vehicle 10 and store various kinds of information necessary for controlling the server 20. The storage 230 may also store encoding specification information corresponding to the traffic volume of the server 20, the data usage of the vehicle 10, the traffic information of the vehicle 10, and the location information of the vehicle 10, respectively.

The storage 230 may be implemented as at least one of a non-volatile memory device (for example, a cache, Read Only Memory (ROM), Programmable ROM (PROM), Erasable Programmable ROM (EPROM), Electrically Erasable Programmable ROM (EEPROM), and flash memory), a volatile memory device (for example, Random Access Memory (RAM)), or a storage medium (for example, Hard Disk Drive (HDD) and Compact Disc Read Only Memory (CD-ROM)), although the storage 230 is not limited to these.

In the above, each structure of the vehicle 10 and the server 20 was described. Hereinafter, the encoding specification in the vehicle 10 and the server 20 will be described in detail.

FIG. 4 is a diagram illustrating a specification corresponding to encoding specification information according to an embodiment of the disclosure.

A controller 130 of a vehicle 10 according to an embodiment may encode an image of the vehicle 10 based on encoding specification information received from the server 20, and direct the transceiver 120 to transmit the encoded image to the server 20.

The controller 130 may adjust at least one of a frame format, a quantity, a resolution, or a compression rate in encoding based on a specification corresponding to encoding specification information.

Specifically, as shown in FIG. 4, as the encoding specification information increases, the controller 130 may adjust the frame format to increase the I-frame (infra frame) and the P-frame previous frame), and decrease the B-frame (bidirectional frame).

In addition, as shown in FIG. 4, as the encoding specification information increases, the controller 130 may adjust the duration to be longer, adjust the resolution to increase, and adjust the compression rate to be lower.

As such, as the encoding specification information increases, the controller 130 may improve the quality of the encoded image by adjusting the encoding specification in an increasing direction. As the encoding specification information decreases, the controller 130 may reduce the capacity of the encoded image by adjusting the encoding specification in a decreasing direction.

In this case, the encoding specification information may be determined based on at least one of a traffic volume of the server 20, a data usage of the vehicle 10, traffic information of the vehicle 10, and location information of the vehicle 10. Hereinafter, the determination of encoding specification information will be described in more detail.

FIG. 5 is a diagram illustrating encoding specification information according to a traffic volume of a server according to an embodiment of the disclosure.

Referring to FIG. 5, the server 20 according to an embodiment may determine encoding specification information in a direction of decreasing encoding specification in proportion to a traffic volume of the server 20.

As a result, the vehicle 10 according to an embodiment may adjust the encoding specification in a decreasing direction in proportion to the traffic volume of the server 20 based on the encoding specification information received from the server 20.

When the traffic volume of the server 20 increases, the image of the vehicle 10 may be processed at a low capacity by encoding of low specification, and thus delays due to processing time may be minimized. Through this, the vehicle 10 may provide an image of the vehicle 10 without delay in real time even in a situation where the traffic volume of the server 20 is large.

FIG. 6 is a diagram illustrating encoding specification information according to data usage of a vehicle according to an embodiment of the disclosure.

Referring to FIG. 6, the server 20 according to an embodiment may determine encoding specification information in a direction of decreasing encoding specification in proportion to a data usage of the vehicle 10.

As a result, the vehicle 10 according to an embodiment may adjust the encoding specification in a decreasing direction in proportion to the data usage of the vehicle 10 based on the encoding specification information received from the server 20.

That is, the vehicle 10 may adjust the encoding specification of the image for the vehicle 10 so that an excessive fee according to data usage is not added based on the data usage of the vehicle 10 within a preset period of time.

FIG. 7 is a diagram illustrating encoding specification information according to traffic amount around a vehicle according to an embodiment of the disclosure.

Referring to FIG. 7, the server 20 according to an embodiment may determine encoding specification information in a direction of increasing encoding specification in proportion to a traffic amount indicated by traffic information of the vehicle 10.

As a result, the vehicle 10 according to an embodiment may adjust the encoding specification in an increasing direction in proportion to the traffic amount indicated by the traffic information of the vehicle 10 based on the encoding specification information received from the server 20.

Accordingly, when the traffic amount increases, the vehicle 10 may provide a user with a clearer image.

FIG. 8 is a diagram illustrating encoding specification information according to congestion degree at a location of a vehicle according to an embodiment of the disclosure.

Referring to FIG. 8, the server 20 according to an embodiment may determine encoding specification information in a direction of increasing encoding specification in proportion to a degree of congestion indicated by location information of the vehicle 10.

For example, the server 20 may determine that the degree of congestion is high as the location of the vehicle 10 indicated by the location information is closer to the location determined as the downtown area. Therefore, the server 20 may determine the encoding specification information in a direction of increasing the encoding specification as the location of the vehicle 10 approaches the downtown area.

As a result, the vehicle 10 according to an embodiment may adjust the encoding specification in an increasing direction in proportion to the degree of congestion indicated by the location information of the vehicle 10 based on the encoding specification information received from the server 20.

Through this, the vehicle 10 may provide a user with a clearer image quality as the degree of congestion increases.

As such, the server 20 according to an embodiment may determine the encoding specification information based on at least one of a traffic volume of the server 20, data usage of the vehicle 10, traffic information of the vehicle 10, and location information of the vehicle 10. For example, the server 20 may determine encoding specification information based on both the traffic volume of the server 20 and the data usage of the vehicle 10. In this case, it may be determined as encoding specification information corresponding to a value obtained by multiplying a factor corresponding to each level.

FIG. 9 is a diagram illustrating an encoding specification that varies according to a type of an image according to an embodiment of the disclosure.

Referring to FIG. 9, the server 20 according to an embodiment may generate a plurality of encoding specification information having a difference in encoding specification according to an image type. In detail, the controller 220 determines encoding specification information based on at least one of a traffic volume of the server 20, a data usage of the vehicle 10, traffic information of the vehicle 10, or location information of the vehicle 10. Thereafter, the controller 220 may generate a plurality of encoding specification information by adjusting the encoding specification information determined according to the type of the image.

For example, the controller 220 of the server 20 may generate one encoding specification information by adjusting the degree of specification indicated by the encoding specification information determined for an image type requiring high specification encoding to increase. In addition, the controller 220 may generate another encoding specification information by adjusting the degree of specification indicated by the encoding specification information determined for an image type requiring low specification encoding to decrease.

The vehicle 10 according to an embodiment may adjust the encoding specification based on the type of the image photographed through the camera 110 by using the plurality of encoding specification information received from the server 20.

In detail, the controller 130 of the vehicle 10 may determine the type of the image based on the object in the image, and encode the image based on the encoding specification information corresponding to the determined type among the encoding specification information received from the server 20.

In this case, when the object in the image is at least one of a moving object or a character, the controller 130 may determine the type of the image as a type requiring high specification encoding. And when the object in the image is not at least one of a moving object or a character, the controller 130 may determine the type of the image as a type requiring low specification encoding.

For example, as shown in FIG. 9, the vehicle 10 may determine a type that requires high specification encoding in case of an image in which an object corresponds to a moving object and may perform encoding of a high specification based on encoding specification information corresponding thereto. In addition, the vehicle 10 may determine a type that requires low specification encoding in case of an image having no motion because the object does not correspond to a moving object, and may perform low specification encoding based on encoding specification information corresponding thereto. As a result, despite the capacity loss in the type of image that requires high specification encoding, due to the capacity gain in the type of image that requires low specification coding, it is a gain in the total capacity. Therefore, the load of the server 20 may be lowered and a fast processing time may be ensured, so that the user may be provided with a delay-free image in real time.

In this manner, the server 20 may transmit a plurality of encoding specification information having a difference in encoding specification according to the type of the image to the vehicle 10. The vehicle 10 may encode each image based on encoding specification information of a type corresponding to each of the plurality of captured images (e.g., front image, rear image, left side image, right side image, internal image, etc.) among the plurality of encoding specification information. In this way, for a low-definition image, by performing low specification encoding, a capacity gain may be achieved and loads on the vehicle 10 and the server 20 may be reduced.

Hereinafter, a control method of the vehicle 10 according to an embodiment will be described. The control method of the vehicle 10 to be described later may be applied to the vehicle 10 according to the above-described embodiment. Therefore, the contents described above with reference to FIGS. 1 to 9 may be equally applicable to the control method of the vehicle 10 according to an embodiment even if there is no special mention.

FIG. 10 is a flowchart illustrating a case of encoding an image based on encoding specification information in a control method of a vehicle according to an embodiment of the disclosure.

Referring to FIG. 10, the vehicle 10 according to an embodiment may capture an image of the vehicle 10 (1010). That is, the vehicle 10 may obtain an image of the vehicle 10 through the camera 110.

When receiving the encoding specification information from the server 20 (YES in 1020), the vehicle 10 according to an embodiment may encode an image based on a specification corresponding to the encoding specification information (1030).

In this case, the vehicle 10 may adjust at least one of a frame format, a quantity, a resolution, or a compression rate in encoding based on a specification corresponding to encoding specification information.

In this case, the encoding specification information may be determined based on at least one of a traffic volume of the server 20, a data usage of the vehicle 10, traffic information of the vehicle 10, and location information (e.g., GPS information) of the vehicle 10.

In detail, the vehicle 10 may adjust the encoding specification in a decreasing direction in proportion to the traffic volume of the server 20 based on the encoding specification information.

In addition, the vehicle 10 may adjust the encoding specification in a decreasing direction in proportion to the data usage of the vehicle 10 based on the encoding specification information.

In addition, the vehicle 10 may adjust the encoding specification in an increasing direction in proportion to the traffic amount indicated by the traffic information of the vehicle 10 based on the encoding specification information.

In addition, the vehicle 10 may adjust the encoding specification in an increasing direction in proportion to a degree of congestion indicated by the location information of the vehicle 10 based on the encoding specification information.

The vehicle 10 according to an embodiment may transmit the encoded image to the server 20 (1040). In this way, the vehicle 10 may provide an image in real time by varying the image of the vehicle based on the processing time and the situation around the vehicle, and may improve the data load.

FIG. 11 is a flowchart illustrating a case in which an image is encoded in consideration of a type of an image in a control method of a vehicle according to an embodiment of the disclosure.

Referring to FIG. 11, the vehicle 10 according to an embodiment may capture an image of the vehicle 10 (1110). That is, the vehicle 10 may obtain an image of the vehicle 10 through the camera 110.

According to an embodiment, the vehicle 10 may determine a type of an image based on an object in the image (1120).

In this case, when the object in the image is at least one of a moving object or a character, the vehicle 10 may determine the type of the image as a type requiring high specification encoding. And when the object in the image is not at least one of a moving object or a character, the vehicle 10 may determine the type of the image as a type requiring low specification encoding.

The vehicle 10 according to an embodiment may determine encoding specification information corresponding to a determined type among encoding specification information received from the server 20 (1130), and may encode an image based on the determined encoding specification information (1140). The vehicle 10 according to an embodiment may transmit the encoded image to the server 20 (1150).

In this manner, the server 20 may transmit a plurality of encoding specification information having a difference in encoding specification according to the type of the image to the vehicle 10. The vehicle 10 may encode each image based on encoding specification information of a type corresponding to each of the plurality of captured images (e.g., front image, rear image, left side image, right side image, internal image, etc.) among the plurality of encoding specification information. In this way, for a low-definition image, by performing low specification encoding, a capacity gain may be achieved and loads on the vehicle 10 and the server 20 may be reduced.

According to the vehicle and the control method thereof according to an aspect, by processing the image of the vehicle based on the processing time and the situation around the vehicle, it is possible to provide an image in real time, and to improve the data load.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

According to the vehicle and the control method thereof according to an aspect, by processing the image of the vehicle based on the processing time and the situation around the vehicle, it is possible to provide an image in real time, and to improve the data load.

1. A vehicle comprising:
a camera configured to capture an image;
a transceiver configured to communicate with a server; and
a controller configured to receive encoding specification information from the server, to encode the image based on a specification corresponding to the encoding specification information and to direct the transceiver to transmit the encoded image to the server,
wherein the encoding specification information is determined based on at least one of traffic volume of the server, data usage of the vehicle, or traffic information of the vehicle.

2. The vehicle according to claim 1, wherein the controller is configured to adjust at least one of a frame format, a quantity, a resolution, or a compression rate in encoding based on the specification corresponding to the encoding specification information.

3. The vehicle according to claim 2, wherein the encoding specification information is further determined based on location information of the vehicle.

4. The vehicle according to claim 1, wherein the controller is configured to adjust an encoding specification in a decreasing direction in proportion to the traffic volume of the server based on the encoding specification information.

5. The vehicle according to claim 1, wherein the controller is configured to adjust an encoding specification in a decreasing direction in proportion to the data usage of the vehicle based on the encoding specification information.

6. The vehicle according to claim 1, wherein the controller is configured to adjust the encoding specification in an increasing direction in proportion to a traffic amount indicated by the traffic information of the vehicle based on the encoding specification information.

7. The vehicle according to claim 3, wherein the controller is configured to adjust the encoding specification in an increasing direction in proportion to a degree of congestion indicated by the location information of the vehicle based on the encoding specification information.

8. The vehicle according to claim 1, wherein the controller is configured to determine a type of the image based on an object in the image and to encode the image based on encoding specification information corresponding to the determined type among the encoding specification information received from the server.

9. The vehicle according to claim 8, wherein the controller is configured to determine the type of the image as a type that requires high specification encoding when the object in the image is at least one of a moving object or a character.

10. A control method of a vehicle comprising a camera and a transceiver in communication with a controller and a server, the method comprising:
receiving encoding specification information from the server, wherein the encoding specification information is determined based on at least one of traffic volume of the server, data usage of the vehicle, or traffic information of the vehicle;
encoding an image captured by the camera based on a specification corresponding to the encoding specification information; and
directing the transceiver to transmit the encoded image to the server.

11. The control method according to claim 10, further comprising:
adjusting at least one of a frame format, a quantity, a resolution, or a compression rate in encoding based on the specification corresponding to the encoding specification information.

12. The control method according to claim 11, wherein the encoding specification information is further determined based on location information of the vehicle.

13. The control method according to claim 10, further comprising:
adjusting an encoding specification in a decreasing direction in proportion to the traffic volume of the server based on the encoding specification information.

14. The control method according to claim 10, further comprising:
adjusting an encoding specification in a decreasing direction in proportion to the data usage of the vehicle based on the encoding specification information.

15. The control method according to claim 10, further comprising:
adjusting the encoding specification in an increasing direction in proportion to a traffic amount indicated by the traffic information of the vehicle based on the encoding specification information.

16. The control method according to claim 12, further comprising:
adjusting the encoding specification in an increasing direction in proportion to a degree of congestion indicated by the location information of the vehicle based on the encoding specification information.

17. The control method according to claim 10, further comprising:
determining a type of the image based on an object in the image; and
encoding the image based on encoding specification information corresponding to the determined type among the encoding specification information received from the server.

18. The control method according to claim 17, wherein determining the type of the image comprises:
determining the type of the image as a type that requires high specification encoding when the object in the image is at least one of a moving object or a character.

19. A vehicle comprising:
a camera configured to capture an image;
a transceiver configured to communicate with a server; and
a controller configured to:
receive encoding specification information from the server;
determine that an object in the image is a moving object or a character;
determine that the image is a type that requires high specification encoding in response to determining that the object in the image is a moving object or a character;
encode the image based on encoding specification information corresponding to the determined type among the encoding specification information received from the server; and
direct the transceiver to transmit the encoded image to the server.

20. The vehicle according to claim 19, wherein the controller is configured to adjust at least one of a frame format, a quantity, a resolution, or a compression rate in encoding based on the specification corresponding to the encoding specification information.
